(19) United States
(12) Patent Application Publication
(10) Pub. No.: US 2015/0266057 A1
(43) Pub. Date: Sep. 24, 2015

(54) ULTRASONIC PROBE

(71) Applicant: Kabushiki Kaisha Toshiba, Minato-ku (JP)

(72) Inventors: Yusuke SUZUKI, Yokohama (JP); Seiichiro Murai, Yokohama (JP)

(73) Assignee: Kabushiki Kaisha Toshiba, Minato-ku (JP)

(21) Appl. No.: 14/625,222

(22) Filed: Feb. 18, 2015

(30) Foreign Application Priority Data
Mar. 20, 2014 (JP) 2014-057913

(51) Int. Cl. B06B 1/06

(52) U.S. Cl. CPC B06B 1/06

(57) ABSTRACT

An ultrasonic probe according to one embodiment, includes a first wiring plate, a second wiring plate and a vibrator. The vibrator is provided between the first wiring plate and the second wiring plate. The vibrator includes a backing material provided on the first wiring plate, a piezoelectric body provided on the backing material, a first acoustic matching layer provided on the piezoelectric body, a second acoustic matching layer provided on the first acoustic matching layer, a first bonding layer having conductive properties and bonding the backing material and the piezoelectric body, a second bonding layer bonding the piezoelectric body and the first acoustic matching layer, and a third bonding layer having insulating properties and bonding the first acoustic matching layer and the second acoustic matching layer.

### CROSS-REFERENCE TO RELATED APPLICATIONS

This application is based upon and claims the benefit of priority from Japanese Patent Application No. 2014-057913, filed on Mar. 20, 2014; the entire contents of which are incorporated herein by reference.

### FIELD

Embodiments described herein relate to an ultrasonic probe.

### BACKGROUND

An ultrasonic probe is developed and is used in the medical field or the like. The ultrasonic probe transmits ultrasonic waves to a target, receives ultrasonic waves reflected back from the target, and thereby forms an image of a shape of the target In such an ultrasonic probe, a plurality of vibrators are arranged between two wiring plates in one dimension or in two dimensions. In each of the vibrators, a backing material, a piezoelectric body, and an acoustic matching layer are stacked in this order. The backing material and the piezoelectric body, and the piezoelectric body and the acoustic matching layer are bonded by bonding layers, respectively.

### BRIEF DESCRIPTION OF THE DRAWINGS

FIG. 1 is a side view illustrating an ultrasonic probe according to a first embodiment;

FIG. 2 is a cross-sectional view illustrating a vibrator of the ultrasonic probe shown in FIG. 1;

FIG. 3 is a cross-sectional view illustrating a conductive bonding layer of the vibrator shown in FIG. 2;

FIGS. 4A and 4B are cross-sectional views illustrating a method of manufacturing the ultrasonic probe according to the first embodiment;

FIG. 5 is a cross-sectional view illustrating a vibrator of an ultrasonic probe according to a second embodiment; and

FIG. 6 is a cross-sectional view illustrating a vibrator of an ultrasonic probe according to a third embodiment.

### DETAILED DESCRIPTION

An ultrasonic probe according to one embodiment, includes a first wiring plate, a second wiring plate and a vibrator. The vibrator is provided between the first wiring plate and the second wiring plate. The vibrator includes a backing material provided on the first wiring plate, a piezoelectric body provided on the backing material, a first acoustic matching layer provided on the piezoelectric body, a second acoustic matching layer provided on the first acoustic matching layer, a first bonding layer having conductive properties and bonding the backing material and the piezoelectric body, a second bonding layer bonding the piezoelectric body and the first acoustic matching layer, and a third bonding layer having insulating properties and bonding the first acoustic matching layer and the second acoustic matching layer.

### First Embodiment

Hereinafter, an embodiment of the invention will be described with reference to the drawings.

First, a first embodiment is described.

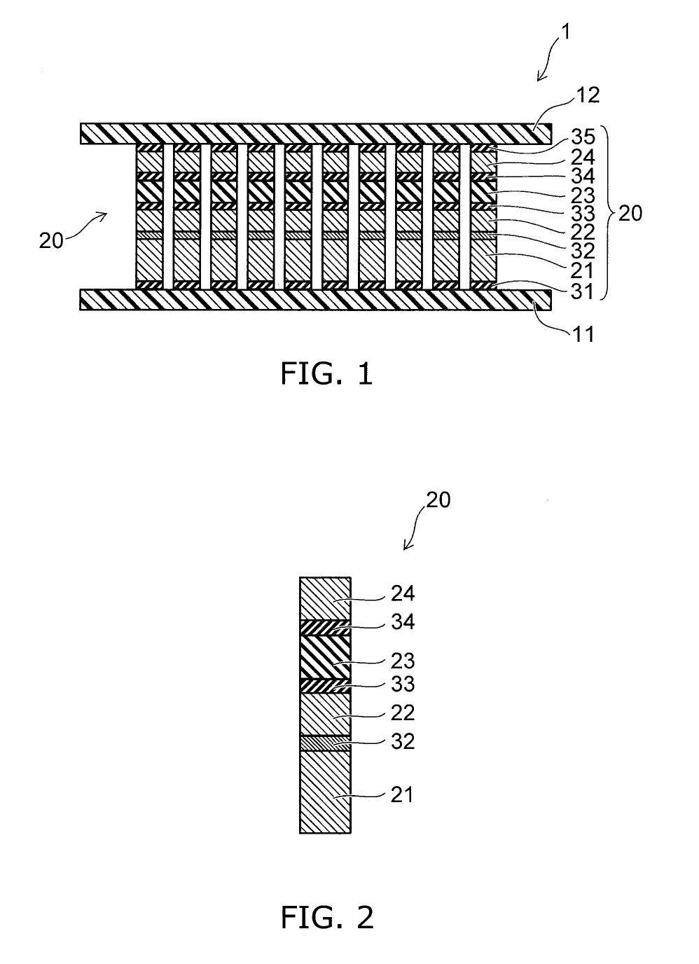

FIG. 1 is a side view illustrating an ultrasonic probe according to the embodiment.

FIG. 2 is a cross-sectional view illustrating a vibrator of the ultrasonic probe shown in FIG. 1.

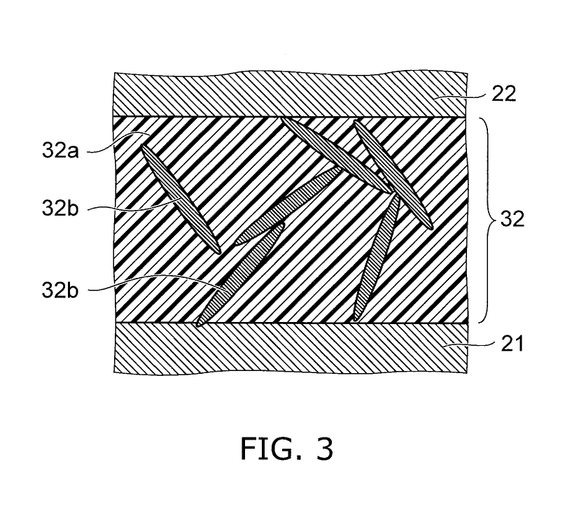

FIG. 3 is a cross-sectional view illustrating a conductive bonding layer of the vibrator shown in FIG. 2.

As illustrated in FIG. 1, in an ultrasonic probe 1 according to the embodiment, two flexible printed wiring plates 11 and 12 are provided in parallel to and spaced from each other. In the flexible printed wiring plates (hereinafter, simply referred to as “wiring plate”) 11 and 12, wiring (not illustrated) is printed on a surface of a substrate that is formed of a resin material. For example, hundreds of vibrators 20 are provided so as to be arranged in a row between the wiring plate 11 and the wiring plate 12. Each vibrator 20 is strip-shaped.

As illustrated in FIG. 2, in each vibrator 20, a backing material 21, a piezoelectric body 22, an acoustic matching layer 23, and an acoustic matching layer 24 (hereinafter, collectively referred to as “member”) are stacked in this order from the wiring plate 11 toward the wiring plate 12. The backing material 21 absorbs sound from the piezoelectric body 22 toward the wiring plate 11 and is a member for suppressing residual vibration. For example, the backing material 21 is formed of cemented carbide and has a thickness of appropriately hundreds of μm (micron). When a voltage is applied, the piezoelectric body 22 vibrates, when vibration is applied, the piezoelectric body 22 transmits the voltage, and the piezoelectric body 22 functions as a transmitting element and as a receiving element of the ultrasonic waves. The piezoelectric body 22 is made of, for example, lead zirconium titanate (PZT) and has a thickness of appropriately 200 μm to 300 μm.

The acoustic matching layers 23 and 24 adjust acoustic impedance and are members for efficiently inputting the ultrasonic waves to the target. The acoustic matching layer 23 is made of, for example, glass and has a thickness of appropriately 200 μm to 300 μm. In addition, the acoustic matching layer 24 is made of, for example, carbon and has a thickness of appropriately 100 μm. Rigidity is increased in the order of the backing material 21, the piezoelectric body 22, the acoustic matching layer 23, the acoustic matching layer 24, and the wiring plates 11 and 12. That is, the backing material 21 has the highest rigidity, next the piezoelectric body 22 has high rigidity. In addition, gold plating is performed on surfaces of the members, but gold plating is not performed on surfaces facing each other in the backing material 21 and the piezoelectric body 22.

In addition, an insulative bonding layer 31 is provided between the wiring plate 11 and the backing material 21, and the backing material 21 is bonded to the wiring plate 11. A conductive bonding layer 32 is provided between the backing material 21 and the piezoelectric body 22 and the piezoelectric body 22 is bonded to the backing material 21. An insulative bonding layer 33 is provided between the piezoelectric body 22 and the acoustic matching layer 23, and the acoustic matching layer 23 is bonded to the piezoelectric body 22. An insulative bonding layer 34 is provided between the acoustic matching layer 23 and the acoustic matching layer 24, and the acoustic matching layer 24 is bonded to the acoustic matching layer 23. An insulative bonding layer 35 is provided between the acoustic matching layer 24 and the wiring plate 12 and the wiring plate 12 is bonded to the acoustic matching layer 24.

As above, among the bonding layer by which the vibrator 20 is bonded to the wiring plates 11 and 12, and bonding layers by which members of the vibrator 20 are bonded to each other, only the conductive bonding layer 32 has conductive properties, and other bonding layers have insulating properties. The thickness of the conductive bonding layer 32 is appropriately 2 μm to 10 μm, and the thickness of the insulative bonding layers 31, and 33 to 35 is 2 μm to 3 μm. When the thickness of the insulative bonding layer is equal to or less than 2 μm to 3 μm, the unevenness of surfaces of the members is not covered completely. Since fine convex portions on the surfaces come into contact with each other, the members are connected electrically to each other. When the insulative bonding layer becomes excessively thick, the convex portions on the surfaces of the members do not come into contact with each other and then the members are nonconductive to each other. As a result, a voltage is not applied to the piezoelectric body 22 and the vibrator 20 is defective.

As illustrated in FIG. 3, in the conductive bonding layer 32, a plurality of fillers 32b are dispersed in the base material 32a which is made of a resin material. The base material 32a is formed of, for example, a thermosetting resin and, for example, is formed of an epoxy resin. The filler 32b is formed of conductive material, and of, for example silver or carbon. There is no particular limitation to the shape of the filler 32b and, the filler 32b has, for example, a grain shape, a needle shape, or a thin plate shape. The maximum diameter of the filler 32b is less than the thickness of the conductive bonding layer 32. The filler is not provided in the insulative bonding layers 31, and 33 to 35, and the insulative bonding layers are formed of thermosetting resin material, for example, an epoxy resin.

Next, a method of manufacturing the ultrasonic probe according to the embodiment is described.

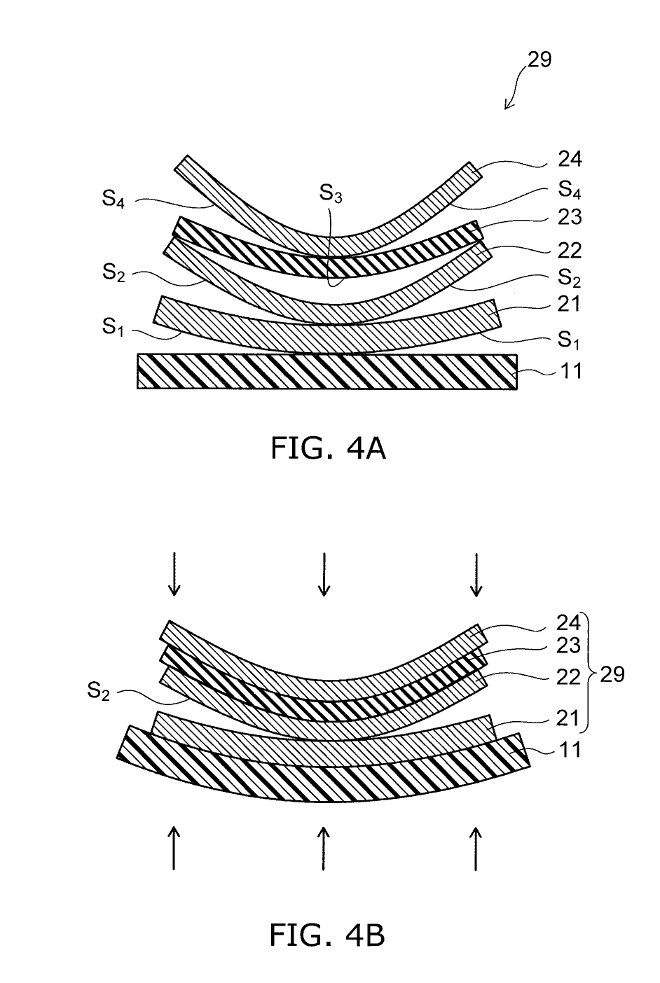

FIGS. 4A and 4B are cross-sectional views illustrating the method of manufacturing the ultrasonic probe according to the embodiment.

In FIGS. 4A and 4B, bending of the members is illustrated to be conspicuous.

First, as illustrated in FIG. 4A, the backing material 21, the piezoelectric body 22, the acoustic matching layer 23, and the acoustic matching layer 24 are stacked in this order on the flexible printed wiring plate 11 through the bonding layers 31 to 34 (refer to FIG. 2) and form a stacked body 29. At this time, the shapes of the members are, for example, a rectangular plate shape of which the length is 60 mm to 70 mm (millimeter) and the width is 15 mm. At this stage, the bending occurs in the members, but the extent of the bending is different from each other depending on the members. For example, the bending of the backing material 21 is appropriately 10 μm, the bending of the piezoelectric body 22 is appropriately 40 μm, the bending of the acoustic matching layer 23 is appropriately 20 μm, and the bending of the acoustic matching layer 24 is appropriately 120 μm. Therefore, gaps S1 to S4 are formed between the members due to the bending difference. The gaps S1 to S4 are filled with the insulative bonding layer 31, the conductive bonding layer 32, the insulative bonding layer 33, and the insulative bonding layer 34, respectively.

Next, as illustrated in FIG. 4B, a compressive force is applied to the stacked body 29 in a direction in which the wiring plate 11 and the acoustic matching layer 24 come closer to each other and the bending of the members is corrected. Thus, the gaps S1 to S4 are decreased and become uniform. However, at this time, among the members, it is difficult to sufficiently correct the gap S2 formed between the backing material 21 which has the highest rigidity and the piezoelectric body 22 which has the second-highest rigidity. The gap S2 remains non-uniform. Next, a heating treatment is performed, and the insulative bonding layer 31, the conductive bonding layer 32, the insulative bonding layer 33, and the insulative bonding layer 34 are cured thermally. Thus, the members are bonded to each other.

Next, as illustrated in FIG. 1, the stacked body 29 is subjected to dicing and divided into a plurality of vibrators 20. Next, the wiring plate 12 is disposed on the vibrator 20 through the insulative bonding layer 35. Next, the heating treatment is performed, and the insulative bonding layer 35 is cured thermally. As described above, the ultrasonic probe 1 is manufactured.

Next, effects of the embodiment are described.

As described above, in a process shown in FIG. 4B, even when a compressive force is applied to the stacked body 29, it is difficult to sufficiently correct the gap S2 formed between the backing material 21 that has the highest rigidity and the piezoelectric body 22 that has the second-highest rigidity. Therefore, in the manufactured ultrasonic probe 1, the conductive bonding layer 32 is thicker than other bonding layers in some vibrators 20. However, in the embodiment, since the conductive bonding layer 32 has conductive properties, it is possible to secure the conductivity between the backing material 21 and the piezoelectric body 22 even when the conductive bonding layer 32 becomes thick. Therefore, the ultrasonic probe 1 has a high electrical reliability. In addition, in the embodiment, it is possible not to perform the gold plating on the surfaces facing each other in the backing material 21 and the piezoelectric body 22. Thus, it is possible to reduce a cost of manufacturing the ultrasonic probe 1.

If an insulative bonding layer is provided instead of the conductive bonding layer 32, the gap S2 is not sufficiently corrected, and when the insulative bonding layer is thick in several vibrators 20, the convex portion on the surface of the backing material 21 and the convex portion on the surface of the piezoelectric body 22 do not come into contact with each other, and thus the backing material 21 and the piezoelectric body 22 become non-conductive to each other. In addition, in the process shown in FIG. 4B, it is considered that a strong force is applied to the stacked body 29 and thereby the gap S2 is caused to be sufficiently thin; however, in this case, the bonding layers which have small gaps originally become too thin, and then the bonding force is degraded. As a result, when dicing is performed on the stacked body 29, there is a possibility that a part of vibrators 20 are broken.

In addition, in the embodiment, between the wiring plate 11 and the backing material 21, between the piezoelectric body 22 and the acoustic matching layer 23, between the acoustic matching layer 23 and the acoustic matching layer 24, and between the acoustic matching layer 24 and the wiring plate 12, the insulative bonding layers 31, 33, 34, and 35 are disposed, respectively. When comparing the insulative bonding layer and the conductive bonding layer, the insulative bonding layer has a higher bonding force by portions where the fillers are not dispersed. Therefore, these members are bonded strongly to each other and the ultrasonic probe 1 according to the embodiment has a high mechanical reliability.

Since the fillers which do not contribute to bonding are contained in the conductive bonding layer, the bonding strength is lower compared to the insulative bonding layer. Therefore, if all the bonding layers are the conductive bonding layer, the mechanical strength of the entire ultrasonic probe is lowered and thus reliability is lowered.

### Second Embodiment

Next, a second embodiment is described.

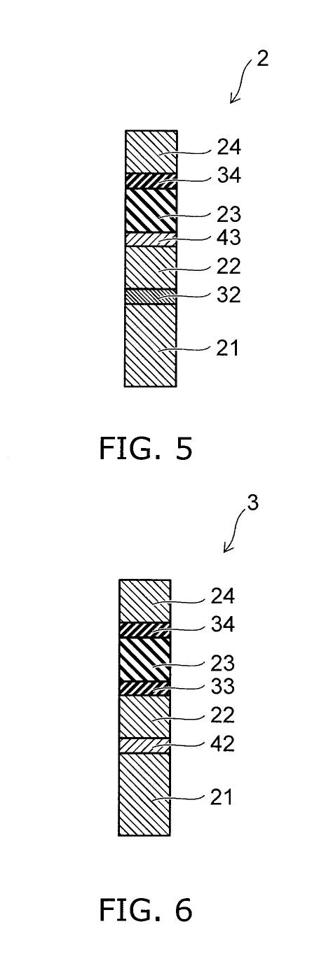

FIG. 5 is a cross-sectional view illustrating a vibrator of an ultrasonic probe according to the embodiment.

As illustrated in FIG. 5, an ultrasonic probe 2 according to the embodiment includes a conductive bonding layer 43 instead of the insulative bonding layer 33, which is a difference compared to the ultrasonic probe 1 (refer to FIG. 2) according to the first embodiment described above.

In the embodiment, among the members, the piezoelectric body 22 that has the second-highest rigidity and the acoustic matching layer 23 that has the third-highest rigidity are bonded by the conductive bonding layer 43. Since the gap S3 between the piezoelectric body 22 and the acoustic matching layer 23 is reduced following the gap S2, the gap S3 is filled with the conductive bonding layer 43, and thereby it is possible to reliably prevent failure of conduction. In the embodiment, configurations other than that described above, a method of manufacturing and the effects are the same as in the first embodiment.

### Third Embodiment

Next, a third embodiment is described. FIG. 6 is a cross-sectional view illustrating a vibrator of an ultrasonic probe according to the embodiment.

As illustrated in FIG. 6, an ultrasonic probe 3 according to the embodiment includes a conductive bonding layer 42 instead of the conductive bonding layer 32, which is a difference compared to the ultrasonic probe 1 (refer to FIG. 2) according to the first embodiment described above. The conductive bonding layer 42 is not formed of the epoxy resin in which fillers are dispersed, but is configured to have an anisotropic conductive film (ACF). In the embodiment, configurations other than that described above, a method of manufacturing and the effects are the same as in the first embodiment.

According to the embodiment described above, it is possible to realize the ultrasonic probe with high reliability.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. Additionally, the embodiments described above can be combined mutually.

What is claimed is:

1. An ultrasonic probe comprising:
a first wiring plate;
a second wiring plate; and
a vibrator provided between the first wiring plate and the second wiring plate,
the vibrator including:
a backing material provided on the first wiring plate;
a piezoelectric body provided on the backing material;
a first acoustic matching layer provided on the piezoelectric body;
a second acoustic matching layer provided on the first acoustic matching layer;
a first bonding layer having conductive properties and bonding the backing material and the piezoelectric body;
a second bonding layer bonding the piezoelectric body and the first acoustic matching layer; and
a third bonding layer having insulating properties and bonding the first acoustic matching layer and the second acoustic matching layer.

2. The probe according to claim 1, wherein the second bonding layer has insulating properties.

3. The probe according to claim 1, wherein the second bonding layer has conductive properties.

4. The probe according to claim 1, wherein the backing material has higher rigidity than the piezoelectric body, the piezoelectric body has higher rigidity than the first acoustic matching layer, and the first acoustic matching layer has higher rigidity than the second acoustic matching layer.

5. The probe according to claim 1, wherein
the first bonding layer includes:
a base material which is formed of a resin material; and
a conductive filler dispersed in the base material.

6. The probe according to claim 5, wherein the base material is a thermosetting resin material.

7. The probe according to claim 6, wherein the thermosetting resin material is an epoxy resin.

8. The probe according to claim 5, wherein the filler is formed of silver.

9. The probe according to claim 5, wherein the filler is formed of carbon.

10. The probe according to claim 5, wherein a maximum diameter of the filler is less than a thickness of the first bonding layer.

11. The probe according to claim 1, wherein the first bonding layer is an anisotropic conductive film.

12. The probe according to claim 1, wherein the first bonding layer has a greater thickness than the third bonding layer.

13. The probe according to claim 1, wherein the first bonding layer has a thickness of 2 μm to 10 μm.

14. The probe according to claim 1, wherein the third bonding layer has a thickness of 2 μm to 3 μm.

15. An ultrasonic probe comprising:
a first wiring plate;
a second wiring plate; and
a vibrator provided between the first wiring plate and the second wiring plate,
the vibrator including:
a plurality of members stacked from the first wiring plate toward the second wiring plate; and
a plurality of bonding layers bonding the adjacent members, and
a first bonding layer of the plurality of bonding layers bonding a member that has the highest rigidity and a member that has the second-highest rigidity among the plurality of members, the first bonding layer having conductive properties, a second bonding layer of the plurality of bonding layers bonding a member that has lowest rigidity and a member that has the second-lowest rigidity among the plurality of members, the second bonding layer having insulating properties.

16. The probe according to claim 15, wherein
the member that has the highest rigidity is a backing material,
the member that has the second-highest rigidity is a piezoelectric body, and
the member that has the lowest rigidity is an acoustic matching layer.
